(19) United States
(12) Patent Application Publication
(10) Pub. No.: US 2005/0076989 A1
(43) Pub. Date: Apr. 14, 2005

(54) Tyres for vehicle wheels with improved bead structure

(76) Inventors: Renato Caretta, Gallarate (IT); Gaetano Lo Presti, Sesto San Giovanni (IT); Rodolfo Noto, Gorgonzola (IT)

Correspondence Address: Finnegan Henderson Farabow;Garrett & Dunner, 1300 I Street NW, Washington, DC, 20005, US

(21) Appl. No.: 10/494,265

(22) PCT Filed: Oct. 31, 2001
(86) PCT No.: PCT/IT01/00554

(51) Int. Cl. B60C 15/05; B60C 15/06; B60C 15/04; B60C 15/00

(52) U.S. Cl. 152/540; 152/543; 152/545; 152/550

(57) ABSTRACT

A tyre for a vehicle wheel includes a toroidal carcass including a central crown portion and two axially opposed sidewalls terminating in beads for mounting on a rim. Each bead includes at least one annular reinforcing core that includes a set of loops or spirals of metallic filament. The carcass is provided with a reinforcing structure including at least one carcass ply reinforced with metallic cords. Ends of the reinforcing structure are fixed to the reinforcing cores. The reinforcing structure includes a neutral profile intersecting cross-sections of fields that delimit the reinforcing cores. The profile includes a continuous curvature without points of inflection along the extension between the beads. At least one auxiliary reinforcing element is provided in at least one of the beads that partially extends within a respective field or in a radially inner portion of at least one sidewall in a position radially external to the field.

The present invention relates to tyres for vehicle wheels, and more specifically to their beads, in other words the annular areas of the carcass which have the function of securing the tyre on the corresponding mounting rim.

More precisely, the aforesaid invention relates to the joint between the annular reinforcing cores inserted in the said beads, more commonly known as bead cores, and the ends of the carcass ply or plies.

A tyre conventionally comprises a toroidal carcass which has a central crown area connected at its ends to a pair of axially opposed sidewalls extending radially inwards, each terminating in a bead designed to fix the tyre to a corresponding mounting rim.

For this purpose, the aforesaid reinforcing bead core is incorporated in the bead.

On the crown of the said carcass and coaxially with it there is provided a tread for the rolling contact of the tyre with the ground, provided with a relief pattern formed by notches and grooves formed in the thickness of the said tread to impart the necessary characteristics of the behaviour of the tyre when in use.

The reinforcing structure of the carcass comprises at least one ply of rubberized fabric, consisting of a sheet of rubber within which are embedded textile or metallic reinforcing cords, arranged transversely with respect to the circumferential direction of the tyre: in tyres with radial carcasses, the direction of the aforesaid cords is orthogonal to the said circumferential direction, in other words to the equatorial plane of the tyre.

If the carcass is of the radial type, it also comprises a belt structure located on the crown of the carcass, interposed between the carcass and the tread, and extending from one side of the tyre to the other, thus having the same width as the tread.

The aforesaid structure conventionally comprises one or more pairs of strips of rubberized fabric, provided with reinforcing cords which are parallel to each other in each strip and cross over those of the adjacent strips, and are preferably inclined in a symmetrical way with respect to the equatorial plane of the tyre.

The axial edges of the mounting rims of the tyre have two coaxial surfaces, generally conical, which form the seats for supporting the tyre beads, these seats being more commonly known as “bead seats”. The axially outer edge of each of the said seats terminates in a flange extending radially outwards, usually known as a “rim flange”, which acts as a support for the axially outer surface of the bead and on which the aforesaid bead is made to bear by the inflation pressure of the tyre.

The force-fitting of the bead of the tyre into its seat is achieved as a result of the conicity of the support seat, which is open outwards, interacting with the metallic reinforcing bead core, which is circumferentially inextensible and therefore has a constant diameter, contained in the tyre bead: this force-fitting, created by the axial thrust exerted axially on the sides of the beads from the inside towards the outside by the inflation pressure of the tyre, ensures the stability of the tyre bead on the rim during use, and, in tyres without inner tubes (tubeless tyres), also provides an air seal between the tyre and the rim in order to prevent the progressive deflation of the tyre.

Given the above considerations, the tyres to which the invention is preferably to be applied are tyres for medium to heavy transport vehicles, of the tubeless type, provided with a metallic radial single-ply carcass, used at operating pressures in the range from approximately 6.5 to 10 bar.

In these tyres, the bead area is a highly critical area which very frequently causes the tyres to become unusable as a result of the structural failure of this area long before the tread has become completely worn.

Many attempts have already been made in the prior art to improve this situation, but without as yet fully resolving the problem: in particular, mention may be made of the attempt to determine the optimal value of the radial height of the carcass ply turn-ups, and the modification of the cross section of the bead core and that of the steel filament from which the bead core is made, sometimes carried out in combination with each other, in order to impart a greater torsional rigidity to the bead core; and also the recent modification of the cross-sectional profile of the carcass ply.

In this connection, an improved solution described by the present applicant in the document WO 00/34059 proposes making the said profiles of the carcass plies pass into the interior of the bead core, and preferably through its centre of gravity.

The first arrangements mentioned above have not been found to resolve the problem. For example, the decrease in flexural rigidity of the bead core achieved by modifying the cross section of the steel filament used to make the bead core significantly improved the ease of fitting and removing the tyre, but the increase in the torsional rigidity of the bead core, achieved by modifying the cross section of the core, failed to compensate for the criticality caused by the presence of the turn-ups of the carcass ply in the bead.

The modification of the profile of the carcass ply, as described in the aforesaid document WO 00/34059, led to significant improvements in terms of behaviour of the tyre in use; this was because, by making the profile of the carcass plies pass through the bead core, preferably through its centre of gravity, the torque discharged by the carcass plies to the bead core of the tyre inflated to operating pressure was successfully eliminated. When the said tyre is in use, the said torque varies with each cycle of rotation of the tyre, generating cyclic micro-movements throughout the bead structure, and particularly micro-rotations of the bead about its axially outer edge and about the edge of the flange, which sooner or later result in the destruction of the tyre.

Although this solution is optimal, it has revealed the persistence of a residual criticality related to the sudden variation of flexural rigidity which the carcass structure undergoes in the transition region between the bead core and the carcass ply: in some cases, the distribution of stresses between the bead cores and carcass associated with this variation can cause the initiation of tears between rubber and metal, and the propagation of the resulting cracks within the carcass structure.

A different solution was proposed in the document WO 99/25572, in which the bead structure includes no cores, while the edge of the carcass ply associated with a reinforcing element has, in each bead, a meridian profile curved in both the axial and the radial direction from the outside towards the inside, to form a reinforcing edge for connection to the mounting rim.

Finally, the solution disclosed in U.S. Pat. No. 3,072,171 proposes, for a tyre made by conventional method, a carcass having at least one carcass ply extending along the bead region of the tyre and under the sidewalls, terminating at the base of the bead, in each bead region, with at least one disc-shaped annular filler formed by thread-like material, the said thread-like material extending circumferentially through the said filler in a plurality of loops parallel to each other and lying adjacent to each other.

The applicant has found that it is possible to produce a new bead structure, particularly for giant tubeless tyres, which has all the advantages of flexibility, elastic deformability and mechanical strength of the known beads, while being free of the disadvantages mentioned above, and particularly having improved characteristics in respect of fatigue resistance, rolling, load capacity and driver comfort.

More specifically, the applicant has found that, if the carcass ply is associated with auxiliary reinforcing elements arranged with an essentially circumferential orientation, the aforesaid sudden variation of rigidity is essentially eliminated, with the creation of a gradient of rigidity variable in the radial direction.

In the present description, the term “auxiliary reinforcing elements” denotes a plurality of elongate elements having a high tensile strength at least, and distributing the forces or stresses exchanged between the bead core and the carcass ply over a portion of the carcass ply which is sufficiently extended in a radial direction to achieve the above effect. In the absence of these auxiliary reinforcing elements, these stresses exchanged between the bead core and the carcass ply would be concentrated in the area delimited by the contact between them.

In a first aspect, the invention therefore relates to a tyre for vehicle wheels, comprising a toroidal carcass which has a central crown portion and two axially opposed sidewalls terminating in a pair of beads for fixing the tyre to a corresponding mounting rim, each bead comprising at least one circumferentially inextensible annular reinforcing core, comprising a set of loops of metallic filament located so that they are radially superimposed on each other and axially adjacent to each other, the said carcass being provided with a reinforcing structure comprising at least one rubberized fabric carcass ply, reinforced with metallic cords lying in radial planes containing the axis of rotation of the tyre, the said reinforcing structure having its ends fixed to the said annular reinforcing cores and a neutral profile, lying in a radial cross-sectional plane, extending axially from one bead to the other, intersecting the cross section of a field which delimits the said annular reinforcing cores, the said neutral profile having a continuous curvature without points of inflection along its extension between the said beads, characterized in that at least one auxiliary reinforcing element, partially extending within the said field, is provided in at least one of the said beads.

In a second aspect, the invention relates to a tyre for vehicle wheels, comprising a toroidal carcass which has a central crown portion and two axially opposed sidewalls terminating in a pair of beads for fixing the tyre to a corresponding mounting rim, each bead comprising at least one circumferentially inextensible annular reinforcing core, comprising a set of loops of metallic filament located so that they are radially superimposed on each other and axially adjacent to each other, the said carcass being provided with a reinforcing structure comprising at least one rubberized fabric carcass ply, reinforced with metallic cords lying in radial planes containing the axis of rotation of the tyre, the said reinforcing structure having its ends fixed to the said annular reinforcing cores, and a neutral profile, lying in a radial cross-sectional plane, extending axially from one bead to the other, intersecting the cross section of a field which delimits the said annular reinforcing cores, the said neutral profile having a continuous curvature without points of inflection along its extension between the said beads, characterized in that at least one auxiliary reinforcing element is provided in the radially inner portion of at least one sidewall, in a position radially external to the said field.

In a further aspect, the invention relates to a method for controlling the stresses present between the carcass ply and the annular reinforcing structure in a tyre for vehicle wheels comprising a toroidal carcass which has a central crown portion and two axially opposed sidewalls terminating in a pair of beads for fixing the tyre to a corresponding mounting rim, each bead comprising at least one circumferentially inextensible annular reinforcing core, comprising a set of spirals of metallic filament located so that they are radially superimposed on each other and axially adjacent to each other, the said carcass being provided with a reinforcing structure comprising at least one rubberized fabric carcass ply, reinforced with metallic cords lying in radial planes containing the axis of rotation of the tyre, the said reinforcing structure having its ends fixed to the said annular reinforcing cores, and a neutral profile, lying in a radial cross-sectional plane, extending axially from one bead to the other, intersecting the cross section of a field which delimits the said annular reinforcing cores, the said neutral profile having a continuous curvature without points of inflection along its extension between the said beads, the said method being characterized in that at least one auxiliary reinforcing element is inserted in at least one of the said beads.

The present invention will, in any case, be more fully understood with the aid of the following description and the attached figures, provided by way of example and without restrictive intent, in which

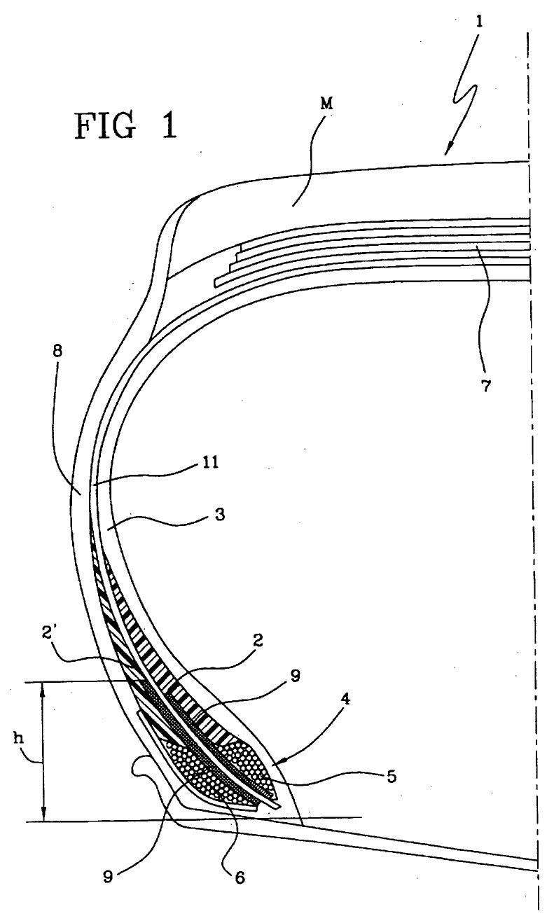

FIG. 1 is a partial cross-sectional view showing the carcass structure of the tyre for motor vehicles according to the invention in a preferred embodiment;

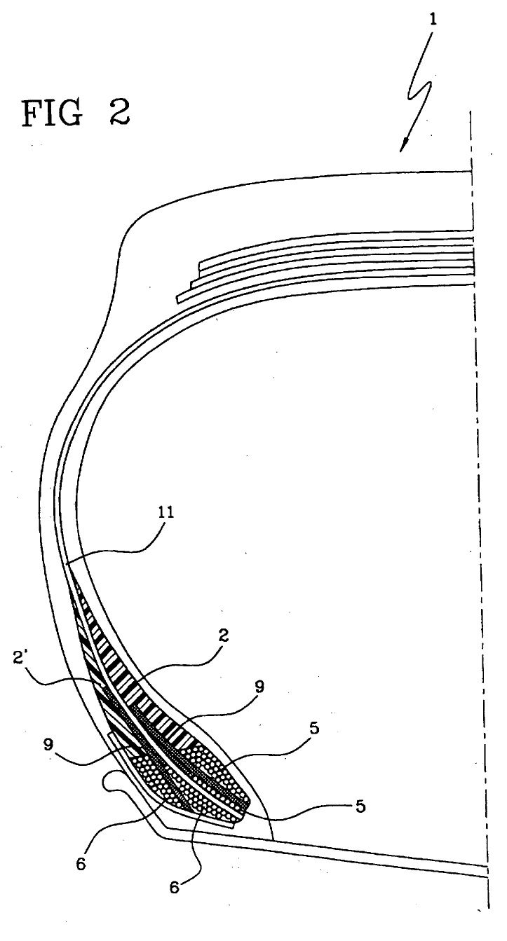

FIG. 2 is a partial cross-sectional view showing the carcass structure of the tyre for motor vehicles in a different preferred embodiment;

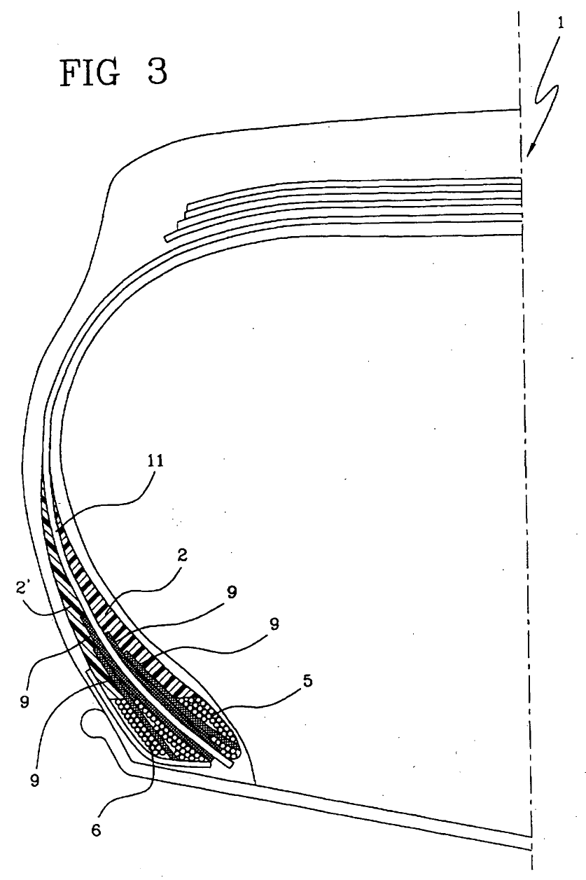

FIG. 3 is a partial cross-sectional view showing the carcass structure of the tyre for motor vehicles according to the invention in a further preferred embodiment;

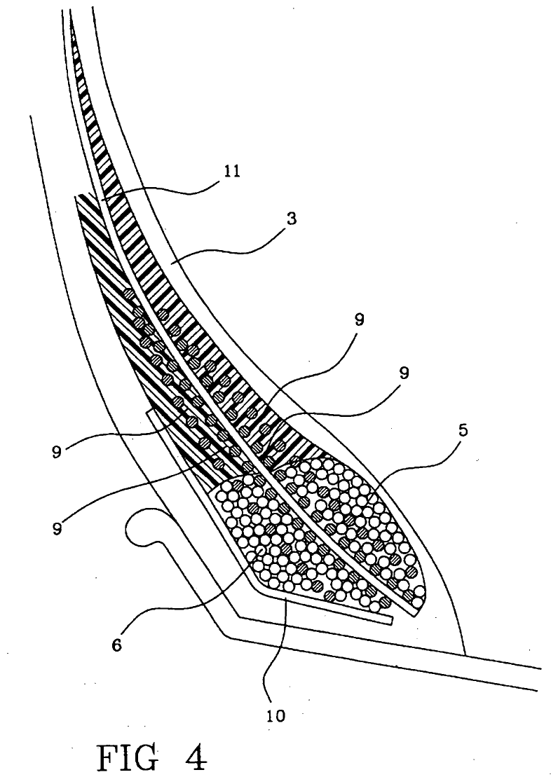

FIG. 4 is an enlarged partial cross-sectional view of the tyre shown in FIG. 3;

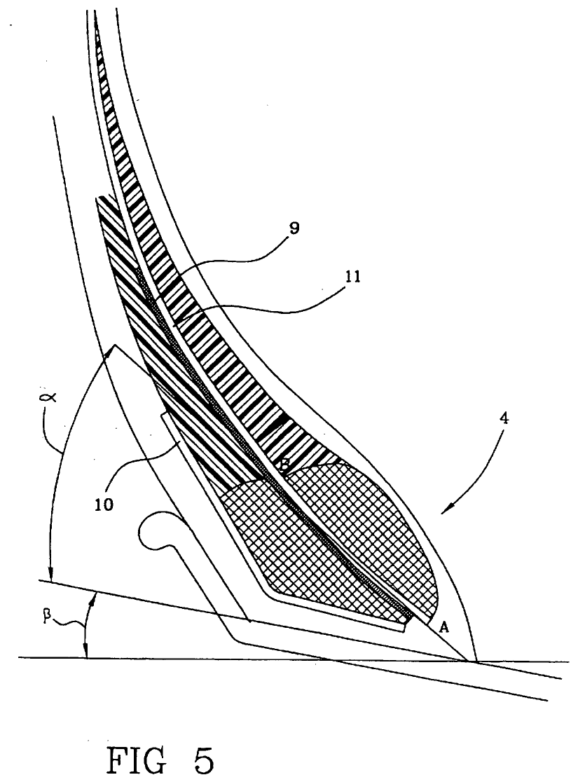

FIG. 5 is a further schematic partial cross-sectional view of the tyre in another embodiment;

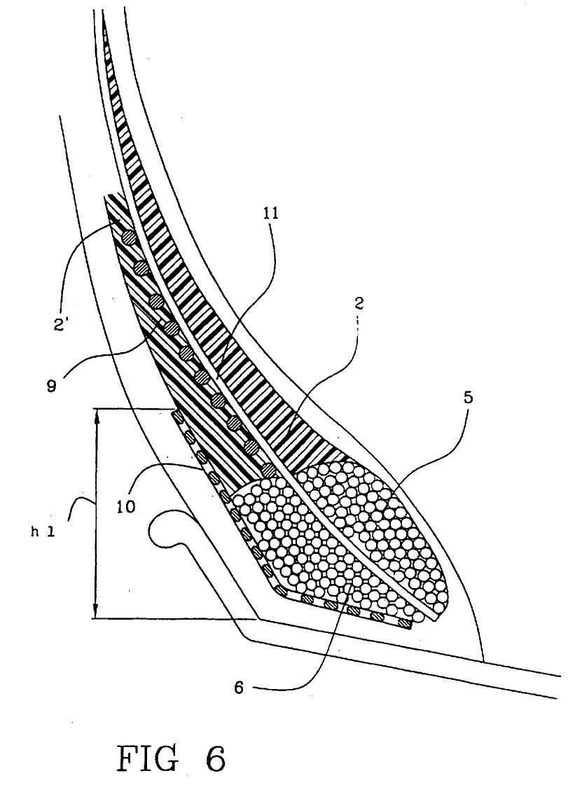

FIG. 6 is an enlarged partial cross-sectional view of a tyre according to the invention in a different embodiment.

In the remainder of the present description, reference will be made to the neutral profile of the reinforcing structure of the carcass: this profile coincides with the profile of the carcass ply when the latter is single or when two or more plies are in contact with each other, but differs from these profiles when they move apart. In this case, the neutral profile corresponds to the profile of the neutral axis of the whole externally delimited by the said plies.

FIG. 1 shows a preferred embodiment of the tyre 1 according to the invention, the said tyre comprising a toroidal carcass, having a central crown area connected at its edges to a pair of axially opposed sidewalls, extending radially inwards and each terminating in a bead for fixing the tyre to a corresponding mounting rim.

The said tyre 1 is preferably made by the process described in the copending European patent application filed by the present applicant and published under no. EP 0 928 680.

The inner elements of the tyre 1 are deposited, starting with what is known as the liner 3, in other words a sheet of rubber which forms the inner, airtight surface of the vulcanized tyre, on a toroidal support whose outer profile coincides with that of the radially inner surface of the raw tyre.

Before the carcass ply is formed, one or more elastomeric fillers 2, whose shape as seen in the cross section of the tyre 1 tapers radially outwards, as shown in FIG. 1, are deposited on the said toroidal support.

A first reinforcing bead core 5 is also formed in a position radially inside the said elastomeric filler 2.

Preferably, the said bead core comprises a circumferentially inextensible annular metal core, consisting of a pack of loops of metallic filament, radially superimposed on each other and axially adjacent to each other.

The pack of loops can be formed by winding onto the said support, or onto a different building drum, a plurality-of loops, radially superimposed on each other and axially adjacent to each other, of a metallic filament, or, alternatively, a cord of metallic filaments, or a band of the said filaments or cords, or a metal strip.

Advantageously, the manufacture of the tyre 1 according to the invention includes the deposition, in a position axially external to the said first bead core 5, of a first auxiliary reinforcing element 9 designed, as explained more fully below, to control the transfer of stresses in the interface between the carcass ply and the bead cores.

More precisely, each auxiliary element 9 has the function of preventing a concentration of large stresses in the proximity of the said interface, to prevent the generation and propagation of cracks in this rather critical area of the bead. In particular, the generation of the said cracks is prevented by the distribution of the stresses acting in this area along a portion which is significantly extended radially towards the outside of the carcass ply, while their propagation is impeded mechanically by the presence of the said elements 9.

The aforesaid auxiliary elements 9 can comprise individual elongate elements made from suitable materials such as natural and synthetic fibres, glass fibre, threads, metallic filaments, textile cords, or metallic cords, the said elements being deposited in the circumferential direction or at an angle to the said direction. Alternatively, they can comprise strips of elastomeric material, reinforced with the aforesaid elongate elements or with fibrous fillers, the preferred fillers being short fibres, fibrillated aramid, more commonly known as Kevlar™ pulp, or cellulose pulp, and assembled in a position axially external to the said bead which is being constructed.

The applicant prefers to use metallic cords of the 3×7×0.20 HE type for making the said auxiliary elements 9, in other words cords consisting of 3 trefoils of 7 filaments, each filament having a diameter of 0.20 mm, in the high-elongation (Lang Lay) configuration, according to the system commonly used for the identification of the said cords.

The said auxiliary elements 9 extend radially outwards to a height “h”, preferably in the range from 20 mm to 150 mm, from the fitting diameter, as measured on the cross section of the tyre 1 (FIG. 1).

The reinforcing structure of the carcass, in other words a carcass ply 11, is then constructed, by depositing on the said toroidal support, in circumferential succession, a plurality of bands, in other words strips of rubberized fabric, each containing a certain number of cords, preferably metal, with the cords arranged radially, in other words at 90° to the circumferential direction of the support. The bands are made to adhere to the underlying layers over the whole of their longitudinal extension, from one bead to the other along the outer surface of the support.

Preferably, each band, having a width in the range from 3 mm to 15 mm, and a thickness in the range from 0.5 mm to 2.5 mm, contains a number of cords in the range from 2 to 15, with a density preferably in the range from 2 to 10 cords per centimetre, as seen on the carcass ply in the circumferential direction in the proximity of the equatorial plane of the tyre 1.

The applicant has found it preferable to use a metallic cord, selected from those commonly used in building tyre carcasses, with each elementary filament having a diameter in the range from 0.14 mm to 0.23 mm, in the known 7×4×0.175 W formation (wrapped cord) with the densities mentioned above.

Preferably, the cords are arranged in the bands with a spacing between their centres of not less than 1.5 times the cord diameter, in order to permit sufficient rubberizing between adjacent cords.

However, if required, the cords can advantageously be arranged in the bands with a higher density, in such a way as to impart particular properties of compactness and uniformity to the carcass ply.

As the manufacture of the aforesaid carcass structure continues, a further auxiliary reinforcing element 9 can be deposited in a position axially external to the aforesaid carcass ply 11, by a process identical to that described above; a second reinforcing bead core 6 is then deposited in a position axially external to this further element. The second bead core also comprises a circumferentially inextensible annular insert, shaped essentially in the form of a circular loop concentric with the axis of rotation of the tyre, and consisting of at least one elongate metal element wound in a plurality of essentially concentric loops, superimposed radially and axially adjacent to each other. The loops can be formed by a continuous spiral or by concentric loops formed by corresponding elongate metal elements.

This is followed by the application of one or more further elastomeric fillers 2′ in a position radially external to the said second bead core 6 and axially external to the said further reinforcing element 9.

The set of the cross-sectional areas of the said bead cores 5 and 6 forms a field 4 which contains the said bead cores. Preferably, the said field 4 essentially delimits the cross-sectional area occupied by the said bead cores.

The said auxiliary reinforcing elements 9 are therefore located in the radially outer portion of at least one sidewall of the tyre, acting in association with the carcass ply and preferably extending additionally into the said field 4 which delimits the bead cores.

It should be noted that, in the tyre according to the invention, the neutral profile of the carcass plies has a continuous curvature without points of inflection along its extension between the beads, and the passage of the said neutral profile into the said field 4, and preferably through the centre of gravity of the set of bead cores, prevents the set of the said bead cores from being subjected to a torque, so that the said set only has to withstand the tensile stresses applied to its cross section as a result of the forcing onto the bead seat.

The material of the bead cores can be any textile or metallic material, or another kind of material, having suitable characteristics of mechanical strength; preferably, this material is the steel filament, either normal or with a high carbon content (high tensile), which is commonly used in tyre manufacturing, or a metallic cord having the corresponding strength and load capacity.

The maximum tensile stress can vary from 500 to 5000 N per filament. The applicant prefers, and finds it advantageous, to use cords in the 2+7×0.52 HT formation (core of two filaments twisted together and ring of seven filaments, each filament having a diameter of 0.52, made from high-carbon steel) and in the 7×3×0.28 formation.

In a different embodiment of the invention, as shown in FIG. 2, the deposition of at least one bead core, but preferably of both cores 5 and 6, is interrupted for the deposition of at least one, but preferably a pair of the said auxiliary reinforcing elements 9, in such a way that, within the said field, the said auxiliary reinforcing elements 9 are separated by the carcass ply 11 and each is retained between two portions of the said bead core. At least one of the said auxiliary reinforcing elements 9, in a position radially external to the said bead cores 5 and 6, extends progressively towards the said carcass ply 11 until it approaches it. In the proximity of this carcass ply, each auxiliary reinforcing element 9 is preferably kept separated from the said carcass ply 11 by a thin layer of elastomeric material.

In a further embodiment of the tyre 1 in question, shown in FIG. 3, the structure of the tyre is formed by interrupting the deposition of at least one bead core for the deposition of at least one further auxiliary reinforcing element 9 by the same methods. Preferably, the said interruption is present in both bead cores, and therefore a total of four of the said auxiliary reinforcing elements 9 are deposited. Preferably, the said elements in the radially external position have their ends staggered in height with respect to each other. In one embodiment, this staggering ranges from 5 to 30 mm.

In a different preferred embodiment of the tyre 1 shown in FIG. 6, at least one of the reinforcing elements according to the invention is deposited on the carcass ply, starting from the radially outer surface of the said field 4 and extending radially outwards.

Advantageously, the tyre 1 according to the invention can also have a reinforcing edge 10 on at least one bead, in a radially inner and axially outer position, comprising elongate reinforcing elements positioned so that they are inclined with respect to the radial direction, these elements being preferably made from metallic cords having elementary filaments with diameters in the range from 0.15 to 0.30 mm. Alternatively, it is possible to use textile cords, made for example from Kevlar, other natural or synthetic fibres, or glass fibre. The said edges 10 can have two sets of elongate elements, the elements of each set being axially superimposed and crossing over those of the adjacent set, or a plurality of the said elongate elements positioned so that they are coplanar and essentially parallel to each other.

The said elements can be placed directly on the carcass structure, or can be previously embedded in a strip of elastomeric material which is subsequently added to the said carcass.

The applicant prefers to use a strip of elastomeric material reinforced with metal cores of the 3×7×0.20 HE type, where the angle of deposition is in the range from 0° to 65°. Preferably, the strip extends to a height “h1” in the range from 10 mm to 70 mm, measured from the fitting diameter of the tyre.

It should be noted that, in the tyre 1 according to the invention (FIG. 5), the end of the carcass ply 11 contained within the said field 4 is significantly inclined towards the axis of rotation of the tyre: in particular, the angle α lying between the bead seat and the straight line connecting the points “A” and “B” of intersection of the said carcass ply 11 with the said field 4 has a value preferably in the range from 0° to 45°. Preferably, the angle β lying between a straight line parallel to the axis of rotation and passing through the axially inner end of the bead and the aforesaid bead seat of the mounting rim is in the range from 0° to 25°, and is usually 15°.

Finally, it should be noted that, in all the described embodiments, the aforesaid auxiliary reinforcing elements 9, which are preferably fixed between the bead cores and extend radially outside them, can, however, extend only in a position external to the cores.

The carcass is finally completed by the deposition of a belt structure 7, the sidewalls 8 and a tread M, and is then moulded and vulcanized.

The tyre according to the invention provides many important benefits, in addition to those essentially arising from the elimination of the torque acting on the bead core.

Overall, as a result of a better distribution of the stresses within the transition region between the more rigid bead and the highly flexible sidewall, the load capacity of the tyre is increased, and a better resistance is achieved to the fatigue cycles to which a tyre is normally subjected during its service life.

In the tyre according to the invention, there is a concentration of smaller stresses in the area immediately adjacent to the radially outer surface of the bead cores in the cords of the carcass plies; more precisely, the particular arrangement of the reinforcing elements inserted into the bead gives rise to a link between the carcass ply and the bead cores, making the values of the said stresses vary gradually along the radial extension of the carcass cords. This essentially eliminates the phenomenon of cracking, in other words the development of separation between the surfaces of the cords and the rubber that covers them, and the propagation of this separation into the structure of the tyre; consequently, the service life is increased. This is because, as mentioned above, the interposition of auxiliary reinforcing elements between the bead cores and the carcass ply, and the particular geometric positioning of the ply and of the said elements, are such that high resistance is achieved to the development and propagation of tears.

It should be mentioned here that the tyre for motor vehicles, when worn, must be capable of being covered with a new tread, at least once but preferably more than once, because of the impact of this possibility on the running costs of the vehicle; however, this operation can only be carried out on undamaged carcasses, and therefore the carcasses sent for retreading are examined and selected as appropriate in advance. The importance of the invention becomes evident when it is considered that many of the conventional carcasses rejected before retreading are eliminated because of faults in the beads.

Owing to its small geometrical dimensions, the pair of bead cores of the tyre according to the invention forms an annular reinforcing core which is highly flexible and therefore capable of deforming easily, assuming in particular the elliptical configuration (ovalization) required to allow the bead to ride over the rim flange during the operation of fitting the tyre to the rim and removing the tyre from the rim, this operation being particularly complicated in the case of giant tyres for motor vehicles.

In addition to this aspect, it should be noted that the tyre in question allows the tyre to be made to bear on the rim in a highly accurate way during fitting, with favourable effects in the long term in relation to structural strength and regularity of wear. This is made possible by the fact that the bead, being particularly flexible, is not subjected to any torque, and can therefore be joined to the rim without jamming.

The applicant considers that the cause of the phenomenon may be as follows. During the stage of fitting the tyre on the rim, carried out at a pressure of 2-3 bar, the base of the bead, suitably lubricated, slides over the inclined base of the rim until it stops when the axially outer surface of the bead comes into contact with the rim flange. The subsequent inflation of the tyre to a value of 3 or 4 bar forces the bead axially into its seat to a precisely predetermined position in which it bears on the rim, and which provides fluid-tightness between the rim and tyre to ensure that the operating pressure of approximately 6.5 to 10 bar is maintained.

Conversely, in a conventional tyre, the tension exerted on the cords of the carcass ply by the inflation pressure, which as stated is of the order of 3 to 4 bar, generates a torque, due to the turn-up of the carcass ply around the bead core, which causes a micro-rotation of the whole bead, so that the radially inner surface of the bead loses its parallelism with the corresponding bead seat on the rim, causing the bead to be jammed against the said seat at its axially outer edges.

1-20. (canceled)

21. A tyre for a vehicle wheel, comprising:
a toroidal carcass;
wherein the carcass comprises:
a central crown portion; and
two axially opposed sidewalls;
wherein each sidewall terminates in a bead for mounting the tyre on a rim,
wherein each bead comprises at least one circumferentially inextensible annular reinforcing core,
wherein each annular reinforcing core comprises a set of loops of metallic filament disposed so that the loops are radially superimposed on each other and axially adjacent to each other,
wherein the carcass is provided with a reinforcing structure comprising at least one rubberized fabric carcass ply,
wherein the at least one carcass ply is reinforced with metallic cords lying in radial planes comprising an axis of rotation of the tyre,
wherein ends of the reinforcing structure are fixed to respective annular reinforcing cores,
wherein the reinforcing structure comprises a neutral profile, lying in a radial cross-sectional plane, extending axially from one bead to the other and intersecting cross-sections of fields that delimit the at least one annular reinforcing core in each bead,
wherein the neutral profile comprises a continuous curvature without points of inflection along the extension between the beads, and
wherein at least one auxiliary reinforcing element is provided in at least one of the beads that partially extends within a respective field.

22. The tyre of claim 21, wherein the at least one auxiliary reinforcing element is disposed between the reinforcing structure and a respective annular reinforcing core.

23. The tyre of claim 21, wherein one or more portions of the at least one auxiliary reinforcing element lies within at least one of the annular reinforcing cores.

24. The tyre of claim 21, wherein the at least one carcass ply intersects the respective field at two points, and
wherein, when the tyre is mounted on the rim, a first angle between a respective bead seat of the rim and a straight line connecting the two points comprises a value greater than or equal to 0° and less than or equal to 45°.

25. The tyre of claim 21, wherein, when the tyre is mounted on the rim, a second angle between a straight line parallel to an axis of rotation of the tyre, passing through an axially inner end of a bead, and a respective bead seat of the rim comprises a value greater than or equal to 0° and less than or equal to 25°.

26. The tyre of claim 21, wherein the at least one auxiliary reinforcing element comprises materials chosen from natural fibers, synthetic fibers, glass fibers, threads, metallic filaments, textile cords, and metallic cords.

27. The tyre of claim 21, wherein the at least one auxiliary reinforcing element comprises second metallic cords of the 3×7×0.20 HE type.

28. The tyre of claim 21, wherein a height of the at least one auxiliary reinforcing element measured in a cross-section of the tyre is greater than or equal to 20 mm and less than or equal to 150 mm.

29. The tyre of claim 21, wherein the tyre further comprises at least one reinforcing edge in a position radially internal and axially external to a respective bead.

30. The tyre of claim 29, wherein the at least one reinforcing edge comprises elongate elements that are inclined with respect to a radial direction.

31. The tyre of claim 30, wherein an angle of deposition of the elongate elements with respect to a circumferential direction is greater than or equal to 0° and less than or equal to 65°.

32. The tyre of claim 30, wherein the elongate elements comprise third metallic cords comprising elementary filaments with diameters greater than or equal to 0.15 mm and less than or equal to 0.3 mm.

33. A tyre for a vehicle wheel, comprising:
a toroidal carcass;
wherein the carcass comprises:
a central crown portion; and
two axially opposed sidewalls;
wherein each sidewall terminates in a bead for mounting the tyre on a rim,
wherein each bead comprises at least one circumferentially inextensible annular reinforcing core,
wherein each annular reinforcing core comprises a set of loops of metallic filament disposed so that the loops are radially superimposed on each other and axially adjacent to each other,
wherein the carcass is provided with a reinforcing structure comprising at least one rubberized fabric carcass ply,
wherein the at least one carcass ply is reinforced with metallic cords lying in radial planes comprising an axis of rotation of the tyre,
wherein ends of the reinforcing structure are fixed to respective annular reinforcing cores,
wherein the reinforcing structure comprises a neutral profile, lying in a radial cross-sectional plane, extending axially from one bead to the other and intersecting cross-sections of fields that delimit the at least one annular reinforcing core in each bead,
wherein the neutral profile comprises a continuous curvature without points of inflection along the extension between the beads, and
wherein at least one auxiliary reinforcing element is provided in a radially inner portion of at least one sidewall in a position radially external to a respective field.

34. The tyre of claim 33, wherein the at least one carcass ply intersects a respective field at two points, and
wherein, when the tyre is mounted on the rim, a first angle between a respective bead seat of the rim and a straight line connecting the two points comprises a value greater than or equal to 0° and less than or equal to 45°.

35. The tyre of claim 33, wherein, when the tyre is mounted on the rim, a second angle between a straight line parallel to an axis of rotation of the tyre, passing through an axially inner end of a bead, and a respective bead seat of the rim comprises a value greater than or equal to 0° and less than or equal to 25°.

36. The tyre of claim 33, wherein the tyre further comprises at least one reinforcing edge in a position radially internal and axially external to a respective bead.

37. A method for controlling stresses present between a carcass and an annular reinforcing structure in a tyre for a vehicle wheel, the method comprising:
inserting at least one auxiliary reinforcing element in at least one bead of the tyre;
wherein the tyre comprises a toroidal carcass,
wherein the carcass comprises:
a central crown portion; and
two axially opposed sidewalls;
wherein each sidewall terminates in a bead for mounting the tyre on a rim,
wherein each bead comprises at least one circumferentially inextensible annular reinforcing core,
wherein each annular reinforcing core comprises a set of spirals of metallic filament disposed so that the spirals are radially superimposed on each other and axially adjacent to each other,
wherein the carcass is provided with a reinforcing structure comprising at least one rubberized fabric carcass ply,
wherein the at least one carcass ply is reinforced with metallic cords lying in radial planes comprising an axis of rotation of the tyre,
wherein ends of the reinforcing structure are fixed to respective annular reinforcing cores,
wherein the reinforcing structure comprises a neutral profile, lying in a radial cross-sectional plane, extending axially from one bead to the other and intersecting cross-sections of fields that delimit the at least one annular reinforcing core in each bead, and
wherein the neutral profile comprises a continuous curvature without points of inflection along the extension between the beads.

38. The method of claim 37, wherein the at least one auxiliary reinforcing element is disposed in a position radially external to a respective field.

39. The method of claim 37, wherein the at least one auxiliary reinforcing element is inserted partially into a respective field.

40. The method of claim 37, wherein the at least one carcass ply intersects a respective field at two points, and
wherein, when the tyre is mounted on the rim, a first angle between a respective bead seat of the rim and a straight line connecting the two points comprises a value greater than or equal to 0° and less than or equal to 45°.
